(19) United States
(12) Patent Application Publication
(10) Pub. No.: US 2025/0077219 A1
(43) Pub. Date: Mar. 6, 2025

(54) Electronic system, electronic apparatus and initialization method thereof having firmware forward and backward compatibility mechanism

(71) Applicant: REALTEK SEMICONDUCTOR CORPORATION, Hsinchu (TW)

(72) Inventor: YU-JEN CHEN, Hsinchu (TW)

(21) Appl. No.: 18/818,672

(22) Filed: Aug. 29, 2024

(30) Foreign Application Priority Data
Sep. 4, 2023 (TW) 112133547

(51) Int. Cl. G06F 8/65; G06F 8/71

(52) U.S. Cl. CPC G06F 8/65; G06F 8/71

(57) ABSTRACT

The present disclosure discloses an electronic system having firmware forward and backward compatibility mechanism. A read-only storage circuit stores first version firmware. A processing circuit configured to store the first version firmware from the read-only storage circuit to a readable and writable storage circuit to perform a system initialization, determine a version of second version firmware included in a driver received from a driver storage terminal is earlier than the first version firmware, merge a variable function having a first version content in the first version firmware and the variable function having a second version content in the second version firmware, replace a first version function pointer in the first version firmware by a second version function pointer in the second version firmware to generate updated firmware having a updated share data section and perform function call according to the updated share data section to continue performing system initialization.

### BACKGROUND OF THE INVENTION

### 1. Field of the Invention

The present disclosure relates to an electronic system, an electronic apparatus and an initialization method thereof having firmware forward and backward compatibility mechanism.

### 2. Description of Related Art

When a peripheral electronic apparatus is connected with a host apparatus, a firmware is loaded thereto first. Subsequently, the peripheral electronic apparatus is driven by the host apparatus according to a driver to perform initialization of the electronic apparatus.

However, a difference between the hardware of the electronic apparatus and the driver of the host apparatus may be presented. In order to allow the hardware to be compatible with the firmware, a plurality of firmware of different versions is required to be stored in the electronic apparatus and the host apparatus in advance. If no efficient initialization method for the electronic apparatus and the host apparatus is provided, the storage of the memory is limited since the full firmware of different versions is required to be stored in the electronic apparatus and the host apparatus in advance.

### SUMMARY OF THE INVENTION

In consideration of the problem of the prior art, an object of the present disclosure is to provide an electronic system, an electronic apparatus and an initialization method thereof having firmware forward and backward compatibility mechanism.

The present invention discloses an electronic apparatus having firmware forward and backward compatibility mechanism that includes a read-only storage circuit, a readable and writable storage circuit and a processing circuit. The read-only storage circuit is configured to store first version firmware that includes at least one variable function corresponding to a first version content and a first shared data section, and the first shared data section includes a first version function pointer of the variable function. The processing circuit is configured to store the first version firmware from the read-only storage circuit to the readable and writable storage circuit to begin to perform a system initialization, determine that a version of the second version firmware included in a driver received from a driver storage terminal is earlier than the version of the first version firmware, wherein the second version firmware includes the variable function corresponding to a second version content and a second shared data section, and the second shared data section includes a second version function pointer of the variable function, in which the second shared data section and the first shared data section have a same section structure, merge the variable function of the first version content and the variable function of the second version content and replace the first version function pointer by the second version function pointer, so to generate updated firmware having an updated shared data section and perform function call according to the updated shared data section of the updated firmware to continue performing the system initialization.

The present invention also discloses an electronic system that includes a driver storage terminal and an electronic apparatus. The electronic apparatus includes a read-only storage circuit, a readable and writable storage circuit and a processing circuit. The read-only storage circuit is configured to store first version firmware that includes at least one variable function corresponding to a first version content and a first shared data section, and the first shared data section includes a first version function pointer of the variable function. The processing circuit is configured to store the first version firmware from the read-only storage circuit to the readable and writable storage circuit to begin to perform a system initialization, determine that a version of the second version firmware included in a driver received from the driver storage terminal is earlier than the version of the first version firmware, wherein the second version firmware includes the variable function corresponding to a second version content and a second shared data section, and the second shared data section includes a second version function pointer of the variable function, in which the second shared data section and the first shared data section have a same section structure, merge the variable function of the first version content and the variable function of the second version content and replace the first version function pointer by the second version function pointer, so to generate updated firmware having an updated shared data section and perform function call according to the updated shared data section of the updated firmware to continue performing the system initialization.

The present invention further discloses an electronic apparatus initialization method used in an electronic apparatus that includes steps outlined below. First version firmware is stored from a read-only storage circuit to a readable and writable storage circuit to begin to perform a system initialization, wherein the first version firmware includes at least one variable function corresponding to a first version content and a first shared data section, and the first shared data section includes a first version function pointer of the variable function. A version of a second version firmware included in a driver received from a driver storage terminal is determined to be earlier than the version of the first version firmware, wherein the second version firmware includes the variable function corresponding to a second version content and a second shared data section, and the second shared data section includes a second version function pointer of the variable function, in which the second shared data section and the first shared data section have a same section structure. The variable function of the first version content and the variable function of the second version content are merged and the first version function pointer is replaced by the second version function pointer, so to generate updated firmware having an updated shared data section. Function call is performed according to the updated shared data section of the updated firmware to continue performing the system initialization.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates a block diagram of an electronic system according to an embodiment of the present invention.

FIG. 2A illustrates a diagram of a structure of the first version firmware according to an embodiment of the present invention.

FIG. 2B illustrates a diagram of a structure of the second version firmware according to an embodiment of the present invention.

FIG. 3 illustrates a diagram of the structure of the updated firmware generated according to the first version firmware in FIG. 2A and the second version firmware in FIG. 2B according to an embodiment of the present invention.

FIG. 4 illustrates a diagram of a first version firmware according to an embodiment of the present invention.

FIG. 5 illustrates a diagram of the structure of the updated firmware generated according to the first version firmware in FIG. 2A and the second version firmware in FIG. 2B according to an embodiment of the present invention.

FIG. 6 illustrates a simplified diagram of the updated firmware actually used in the system initialization according to an embodiment of the present invention.

FIG. 7 illustrates a block diagram of an electronic system according to another embodiment of the present invention.

FIG. 8 illustrates a flow chart of an electronic apparatus initialization method according to an embodiment of the present invention.

### DETAILED DESCRIPTION OF THE PREFERRED EMBODIMENTS

An aspect of the present invention is to provide an electronic system, an electronic apparatus and an initialization method thereof having firmware forward and backward compatibility mechanism to load first version firmware in a read-only storage circuit to a readable and writable storage circuit and receive a second version firmware from a driver storage terminal to merge functions of the first version firmware and the second version firmware and replace the pointers of the functions in the first version firmware by the pointers of the corresponding functions in the second version firmware when the version of the functions in the first version firmware are different from the version of the corresponding functions in the second version firmware such that the electronic apparatus performs function call according to the updated pointers to perform system initialization. The compatibility of different firmware versions can be accomplished.

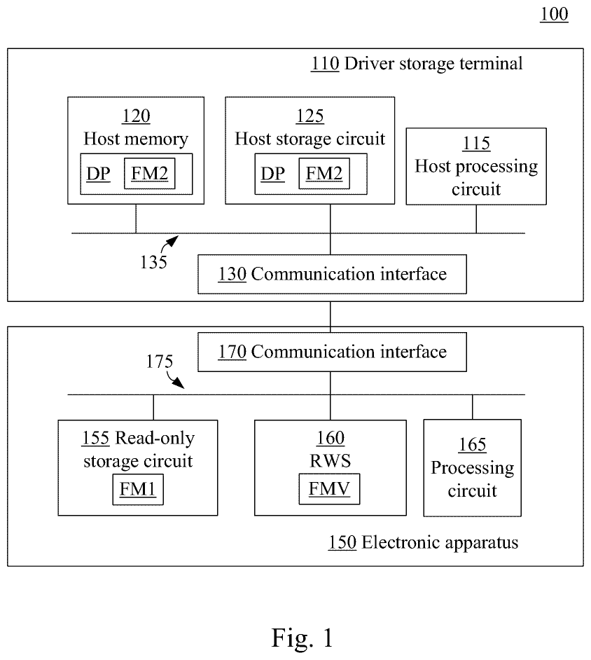

Reference is now made to FIG. 1. FIG. 1 illustrates a block diagram of an electronic system 100 having according to an embodiment of the present invention. The electronic system 100 includes a driver storage terminal 110 and an electronic apparatus 150.

In the present embodiment, the driver storage terminal 110 is a host apparatus independent from the electronic apparatus 150 and includes a host processing circuit 115, a host memory 120, a host storage circuit 125 and a communication interface 130.

The host memory 120 can be such as, but not limited to a random access memory (RAM). The host storage circuit 125 can be such as, but not limited to a hard drive or a flash memory and is configured to store a driver DP of the electronic apparatus 150. The communication interface 130 can be such as, but not limited to interfaces of Peripheral Component Interconnect Express (PCIe), Secure Digital Input/Output (SDIO), Universal Serial Bus (USB) or other interfaces. The components described above can be connected to perform communication through a bus 135 in the driver storage terminal 110 under the control of the host processing circuit 115.

The electronic apparatus 150 can be such as, but not limited to a network card or other peripheral apparatus and includes a read-only storage circuit 155, a readable and writable storage circuit 160 (abbreviated as RWS in FIG. 1), a processing circuit 165 and a communication interface 170.

The read-only storage circuit 155 can be such as, but not limited to a read only memory (ROM) and is configured to store first version firmware FM1. The readable and writable storage circuit 160 can be such as, but not limited to a dynamic random access memory (DRAM). The communication interface 170 is to perform communication with the communication interface 130 and can be such as, but not limited to interfaces of PCIe, SDIO, USB or other interfaces. The components described above can be connected and communicated through a bus 175 in the electronic apparatus 150 under the control of the processing circuit 165.

When the electronic apparatus 150 and the driver storage terminal 110 is connected through the communication interface 130 and the communication interface 170 in order to perform a system initialization, the electronic apparatus 150 stores the first version firmware FM1 from the read-only storage circuit 155 to the readable and writable storage circuit 160 by using the processing circuit 165 to begin to perform the system initialization. Under such a condition, the processing circuit 165 may execute a part of the functions in the first version firmware FM1 to activate a part of the functional circuits and buses.

The driver storage terminal 110 may retrieve the driver DP from the host storage circuit 125 to be stored in the host memory 120 by using the host processing circuit 115 and transmit second version firmware FM2 included by the driver DP through the communication interface 130 such that the electronic apparatus 150 receives the second version firmware FM2.

In an embodiment, the driver DP may actually include a plurality of firmware corresponding to different versions. The electronic apparatus 150 is configured to perform a handshake process with the driver storage terminal 110 such that the driver storage terminal 110 retrieves one of the firmware that matches the electronic apparatus 150 as the second version firmware FM2. It is appreciated that the term “match” describes a condition that the version of the selected firmware does not necessarily exactly matches the version of the electronic apparatus 150. Instead, the version of the firmware that is closest to the version of the electronic apparatus 150 is considered to be “matched”.

In an embodiment, when the electronic apparatus 150 is a relatively newly-designed hardware and the version of the firmware of the driver DP is older than the version of the electronic apparatus 150, the processing circuit 165 of the electronic apparatus 150 determines that the version of the second version firmware FM2 is earlier than the version of the first version firmware FM1.

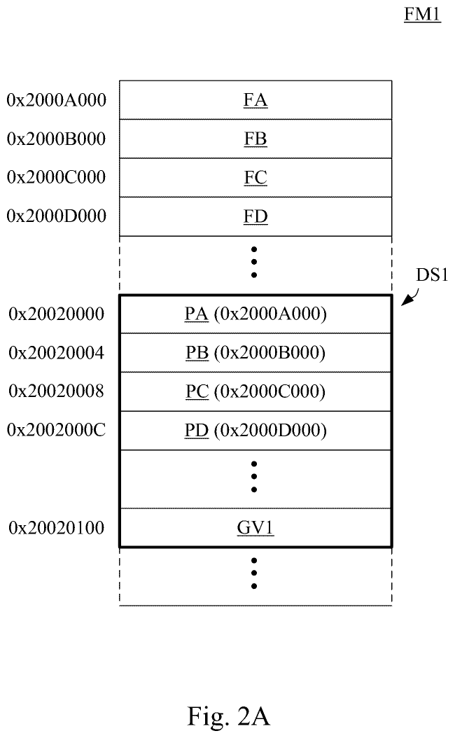

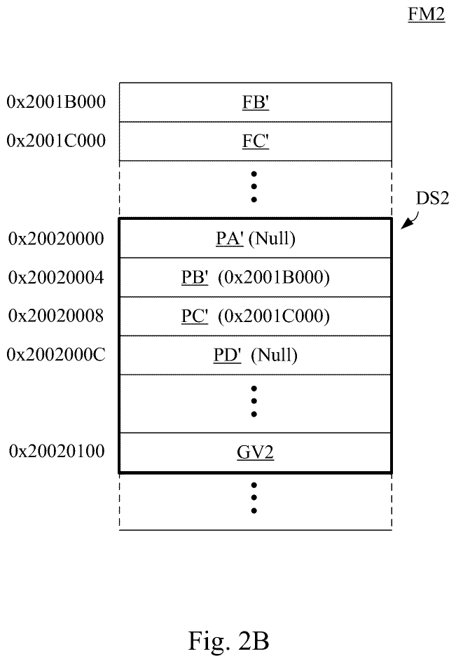

Reference is now made to FIG. 2A and FIG. 2B. FIG. 2A illustrates a diagram of a structure of the first version firmware FM1 according to an embodiment of the present invention. FIG. 2B illustrates a diagram of a structure of the second version firmware FM2 according to an embodiment of the present invention.

In an embodiment, the first version firmware FM1 includes at least one variable function corresponding to a first version content, a first shared data section and a first global variable section. The second version firmware FM2 includes at least one variable function corresponding to a second version content, a second shared data section and a second global variable section. Besides, the first version firmware FM1 further includes a non-variable function that is only used in the second version firmware FM2.

Take the embodiment in FIG. 2A as an example, the first version firmware FM1 includes functions FA˜FD and a first shared data section DS1.

The function FB and the function FC included in the first version firmware FM1 are variable functions corresponding to the first version content. In the embodiment in FIG. 2A, the address that the function FB corresponds to is 0x2000B000 and the address that the function FC corresponds to is 0x2000C000. The function FA and the function FD included in the first version firmware FM1 are non-variable functions can be used in the second version firmware FM2. In the embodiment in FIG. 2A, the address that the function FA corresponds to is 0x2000A000 and the address that the function FD corresponds to is 0x2000D000.

The first shared data section DS1 includes first version function pointers of the variable functions and second pointers of the non-variable functions. In the embodiment in FIG. 2A, the first shared data section DS1 stores pointers PA˜PD. The pointer PB and the pointer PC are the first version function pointers of the variable functions and are respectively recorded in the address 0x20020004 and the address 0x2002000C. The content of the pointer PB is the address 0x2000B000 that the function FB corresponds to. The content of the pointer PC is the address 0x2000C000 that the function FC corresponds to.

The pointer PA and the pointer PD are the second pointers of the non-variable functions and are respectively recorded in the address 0x20020000 and the address 0x2002000C. The content of the pointer PA is the address 0x2000A000 that the function FA corresponds to. The content of the pointer PD is the address 0x2000D000 that the function FD corresponds to.

The first shared data section DS1 further includes a first global variable section GV1. The first global variable section GV1 records global variables that each of the functions in the first version firmware FM1 may use. In the embodiment in FIG. 2A, the first global variable section GV1 corresponds to the address 0x20020100.

Take the embodiment in FIG. 2B as an example, the second version firmware FM2 includes a function FB′, a function FC′ and a second shared data section DS2.

The function FB′ and the function FC′ included in the second version firmware FM2 are variable functions corresponding to the second version content. The addresses that the function FB′ and the function FC′ correspond to are different from the addresses that the function FB and the function FC correspond to. In the embodiment in FIG. 2B, the address that the function FB′ corresponds to is 0x2001B000 and the address that the function FC′ corresponds to is 0x2001C000.

The second shared data section DS2 and the first shared data section DS1 have the same section structure. In an embodiment, the section structure includes an address allocation configuration and a section length. The address allocation configuration includes a base address and the addresses of the information included in the section.

The second shared data section DS2 includes second version function pointers of the variable functions and invalid pointers of the non-variable functions. The addresses of the second version function pointers and the invalid pointers correspond to the addresses of the first version function pointers and second pointers. In the embodiment in FIG. 2B, the second shared data section DS2 stores pointer PA′˜PD′. The pointer PB′ is the second version function pointer of the variable function and is recorded in the address 0x20020004 that corresponds to pointer PB included in the first shared data section DS1. The content of the pointer PB′ is the address 0x2001B000 that the function FB′ corresponds to. The pointer PC′ is also the second version function pointer of the variable function and is recorded in the address 0x20020008 that corresponds to the pointer PC included in the first shared data section DS1. The content of the pointer PC′ is the address 0x2001C000 that the function FC′ corresponds to.

The pointer PA′ is the invalid pointer corresponding to the non-variable function and is recorded in the address 0x20020000 that corresponds to the pointer PA included in the first shared data section DS1. The content of the pointer PA′ is null. The pointer PD′ is the invalid pointer corresponding to the non-variable function and is recorded in the address 0x2002000C that corresponds to the pointer PD included in the first shared data section DS1. The content of the pointer PD′ is null.

The second shared data section DS2 further includes a second global variable section GV2. The second global variable section GV2 records global variables that each of the functions in the second version firmware FM2 may use. In the embodiment in FIG. 2B, the second global variable section GV2 also corresponds to the address 0x20020100. The first global variable section GV1 and the second global variable section GV2 include a shared data structure to record the same global variables.

When the first version firmware FM1 uses new global variables due to the functions having a relatively newer version included therein, the first global variable section GV1 includes a non-shared data structure disposed behind the shared data structure. The second global variable section GV2 does not include such a non-shared data structure.

For example, the first global variable section GV1 and second global variable section GV2 may include a shared data structure that includes variables a, b, c and d. The first global variable section GV1 may further include a non-shared data structure that includes a variable e. In an embodiment, each of the global variables included by the first global variable section GV1 and the second global variable section GV2 has a variable attribute used to perform version identification.

It is appreciated that in practical implementation, the first version firmware FM1 and the second version firmware FM2 may keep the sections thereof for storing the functions having the same size and keep the sections thereof for storing the global variables having the same size, such that the uniformity and the expandability of the function sections and the global variable sections can be maintained.

The processing circuit 165 merges the variable functions of the first version content and the variable functions of the second version content and replaces the first version function pointers included in the first shared data section DS1 of the first version firmware FM1 stored in the readable and writable storage circuit 160 by the second version function pointers, so to generate updated firmware FMU having an updated shared data section. The processing circuit 165 keeps the non-variable function pointer in the updated shared data section according to the invalid pointer to generate the updated firmware FMU.

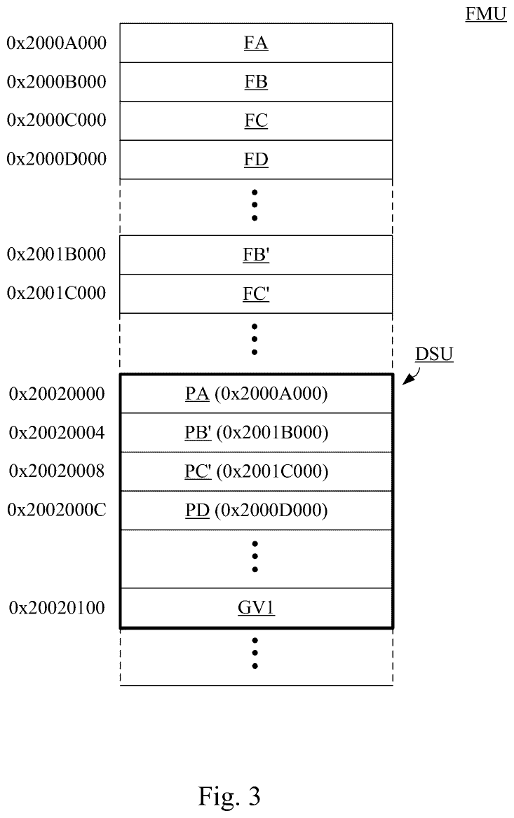

Reference is now made to FIG. 3. FIG. 3 illustrates a diagram of the structure of the updated firmware FMU generated according to the first version firmware FM1 in FIG. 2A and the second version firmware FM2 in FIG. 2B according to an embodiment of the present invention.

In the present embodiment, the updated firmware FMU includes the functions FA˜FD and the functions FB′˜FC′. After being merged, the addresses of the functions FA˜FD and the functions FB′˜FC′ still correspond to 0x2000A000, 0x2000B000, 0x2000C000, 0x2000D000, 0x2001B000 and 0x2001C000.

The updated firmware FMU further includes an updated shared data section DSU, and the updated shared data section DSU includes the pointer PA, the pointer PB′, the pointer PC′ and the pointer PD.

Since the pointer PA′ of the second shared data section DS2 is the invalid pointer corresponding to the non-variable function, the processing circuit 165 keeps the pointer PA corresponding to the address 0x20020000 in the updated shared data section DSU, in which the content of the pointer PA is still the address 0x2000A000 that the function FA corresponds to. Since the pointer PB′ in the second shared data section DS2 is still valid, the processing circuit 165 replaces the pointer PB by the pointer PB′ corresponding to the address 0x20020004 and including the content of the address 0x2001B000 that the function FB′ corresponds to.

Since the pointer PC′ in the second shared data section DS2 is still valid, the processing circuit 165 replaces the pointer PC by the pointer PC′ corresponding to the address 0x20020008 and including the content of the address 0x2001C000 that the function FC′ corresponds to. Since the pointer PD′ of the second shared data section DS2 is the invalid pointer corresponding to the non-variable function, the processing circuit 165 keeps the pointer PD corresponding to the address 0x2002000C in the updated shared data section DSU, in which the content of the pointer PD is still the address 0x2000D000 that the function FD corresponds to.

The updated shared data section DSU of the updated firmware FMU further keeps the first global variable section GV1 that still corresponds to the address 0x20020100.

The processing circuit 165 performs function call according to the updated shared data section DSU of the updated firmware FMU to continue performing the system initialization. More specifically, after the updated firmware FMU is generated, under the condition that the processing circuit 165 executes the variable functions during the process of the system initialization, the processing circuit 165 calls the variable functions corresponding to the second version according to the second version function pointers (i.e., call the function FB′ according to the pointer PB′ or call the function FC′ according to the pointer PC′). Under the condition that the processing circuit 165 executes the non-variable functions, the processing circuit 165 calls the non-variable function according to the non-variable function pointer (i.e., call the function FA according to the pointer PA or call the function FD according to the pointer PD).

As a result, when the electronic apparatus 150 is a relatively newly-designed hardware that provides firmware corresponding to a relatively newer version and the version of the firmware of the driver DP is older than the version of the electronic apparatus 150 that is only capable of providing firmware corresponding to a relatively older version, the electronic apparatus 150 allows the hardware corresponding to the newer version to execute the firmware corresponding to the older version.

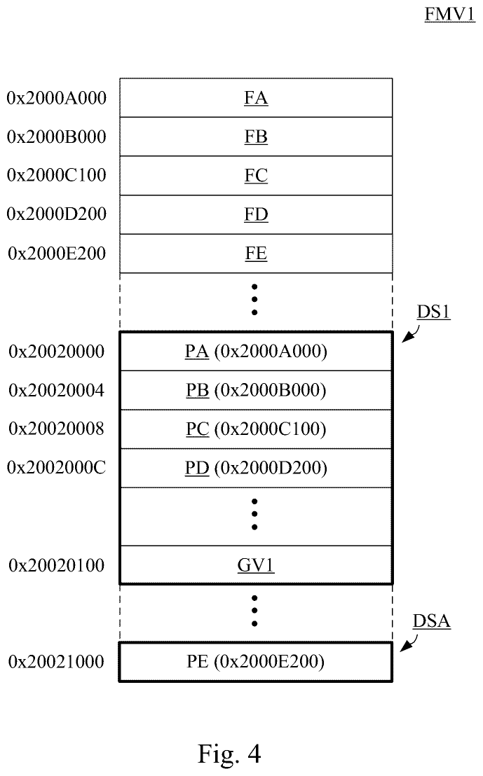

Reference is now made to FIG. 4. FIG. 4 illustrates a diagram of a first version firmware FMV1 according to an embodiment of the present invention.

Similar to the embodiment in FIG. 2A, the first version firmware FMV1 in FIG. 4 includes the function FB and the function FC that are the variable functions, the function FA and the function FD that are the non-variable functions and the first shared data section DS1 that includes the first global variable section GV1.

In the present embodiment, the first version firmware FMV1 has a larger degree of modification relative to the second version firmware FM2. The function FB and the function FC that are the variable functions have contents that occupy a larger storage space, in which the function FC corresponds to the address 0x2000C100 and the function FD corresponds to the address 0x2000D200.

Moreover, the first version firmware FMV1 further includes a function FE, in which the function FE is a third function not included in the second version firmware FM2. In the embodiment in FIG. 4, the address that the function FE corresponds to is 0x2000E200.

Further, the first version firmware FMV1 includes an additional shared data section DSA, and the additional shared data section DSA includes a pointer PE. The pointer PE is a third function pointer of the third function and is recorded in the address 0x20021000. The content of the pointer PE is the address 0x2000E200 that the function FE corresponds to.

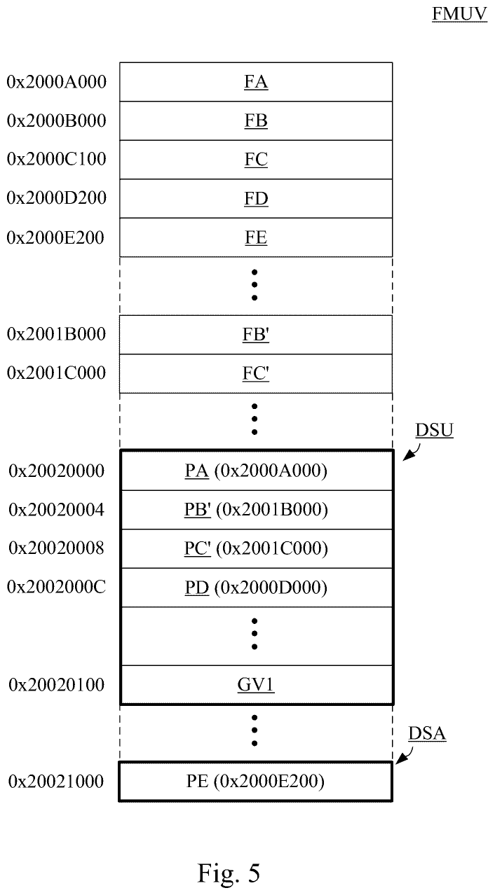

Reference is now made to FIG. 5. FIG. 5 illustrates a diagram of the structure of the updated firmware FMUV generated according to the first version firmware FMV1 in FIG. 2A and the second version firmware FM2 in FIG. 2B according to an embodiment of the present invention.

In the present embodiment, the updated firmware FMUV includes the functions FA˜FE and the functions FB′˜FC′. After being merged, the addresses of the functions FA˜FE and the functions FB′˜FC′ still correspond to 0x2000A000, 0x2000B000, 0x2000C100, 0x2000D200, 0x2000E200, 0x2001B000 and 0x2001C000.

The updated firmware FMUV further includes an updated shared data section DSU and an additional shared data section DSA. The updated shared data section DSU includes the pointer PA, the pointer PB′, the pointer PC′ and the pointer PD. The pointer PA corresponds to the address 0x20020000 and has a content of the address 0x2000A000 that the function FA corresponds to. The pointer PB′ corresponds to the address 0x20020004 and has a content of the address to 0x2001B000 that the function FB′ corresponds. The pointer PC′ corresponds to the address 0x20020008 and has a content of the address 0x2001C000 that the function FC′ corresponds to. The pointer PD corresponds to the address 0x2002000C and has a content of the address 0x2000D200 that the function FA corresponds to. The pointer PE included in the additional shared data section DSA corresponds to the address 0x20021000 and has a content of the address 0x2000E200 that the function FE corresponds to.

The updated shared data section DSU of the updated firmware FMUV further keeps the first global variable section GV1 that still corresponds to the address 0x20020100.

As a result, even if the contents between the firmware of different versions are different or newly added functions are presented, the processing circuit 165 is still able to execute the firmware corresponding to the older version on the hardware corresponding to the newer version.

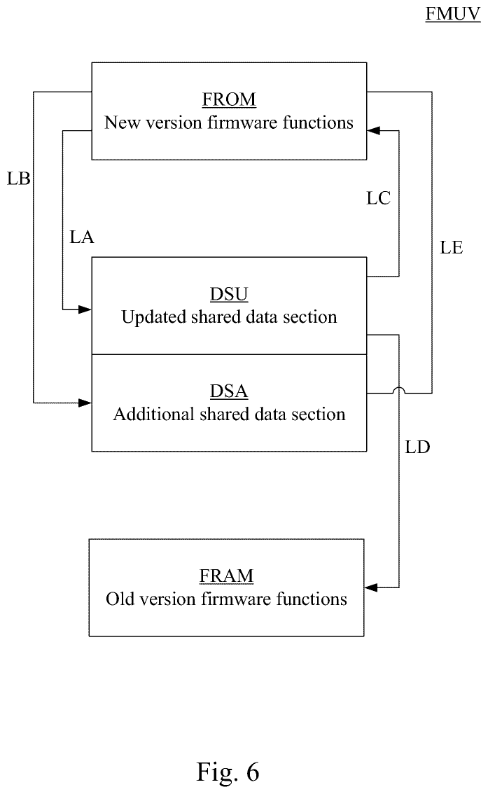

Reference is now made to FIG. 6. FIG. 6 illustrates a simplified diagram of the updated firmware FMUV actually used in the system initialization according to an embodiment of the present invention.

The updated firmware FMUV actually used in the system initialization includes new version firmware functions FROM (including the function FA, the function FD and function FE in FIG. 5) provided by the read-only storage circuit 155 of the electronic apparatus 150, old version firmware functions FRAM (including the functions FB′˜FC′ in FIG. 5) provided by the host memory 120 of the driver storage terminal 110, an updated shared data section DSU and an additional shared data section DSA.

When the new version firmware functions FROM are executed, the path LA toward the updated shared data section DSU or the path LB toward the additional shared data section DSA can be used to refer to the pointers of the other functions and call the functions accordingly. For the updated shared data section DSU, whether the path LC toward the new version firmware functions FROM or the path LD toward the old version firmware functions FRAM can be used to call and execute the functions. On the contrary, for the additional shared data section DSA, only the path LE toward the new version firmware function FROM can be used to call and execute the functions.

The embodiments described above are based on the condition that the firmware having the older version is executed on the hardware having the newer version. In an embodiment, the electronic apparatus 150 may accomplish the operation of the driver DP having the newer version executed on the hardware having the older version by using the configuration of the driver DP in the driver storage terminal 110.

More specifically, the driver storage terminal 110 may store a plurality of firmware of different old and new versions. When the electronic apparatus 150 corresponds to hardware of an older version and the driver storage terminal 110 stores the driver DP corresponding to a newer version and is able to provide firmware corresponding to the older versions, the driver storage terminal 110 may retrieve the firmware that matches the electronic apparatus 150 through the handshake process described above and transmits such firmware to the electronic apparatus 150 to operate accordingly.

In some approaches, in order to allow the electronic apparatus to be compatible with the version of the driver in the driver storage terminal, a plurality of firmware of different versions is required to be stored in the read-only storage circuit of the electronic apparatus, and a plurality of firmware of different versions is required to be stored in the host memory of the driver storage terminal as well. Not only a large amount of common codes are presented among the firmware of different versions to waste the storage, but also the number of the firmware of different versions to be stored is limited due to the limited storage amount.

The electronic apparatus of the present invention loads first version firmware in a read-only storage circuit to a readable and writable storage circuit and receives a second version firmware from a driver storage terminal to merge functions of the first version firmware and the second version firmware and replace the pointers of the functions in the first version firmware by the pointers of the corresponding functions in the second version firmware when the version of the functions in the first version firmware are different from the version of the corresponding functions in the second version firmware such that the electronic apparatus performs function call according to the updated pointers to perform system initialization. The compatibility of different firmware versions can be accomplished.

In the embodiment in FIG. 1, the condition that the driver storage terminal 110 a host apparatus independent from the electronic apparatus 150 is used as an example. However, in another embodiment, the driver storage terminal 110 can be a master apparatus disposed in a system-on-a-chip together with the electronic apparatus 150. More specifically, the electronic system 100 is a system-on-a-chip, in which each of the driver storage terminal 110 and the electronic apparatus 150 is a circuit block of such a system-on-a-chip.

As a result, the communication interface 130 can be a bus master of the system-on-a-chip and the communication interface 170 can be a bus slave of the system-on-a-chip such that the driver storage terminal 110 and the electronic apparatus 150 may perform communication through such as, but not limited to Advanced Microcontroller Bus Architecture (AMBA). The electronic apparatus 150 may accomplish the firmware forward and backward compatibility mechanism with the driver storage terminal 110 by using the method described above.

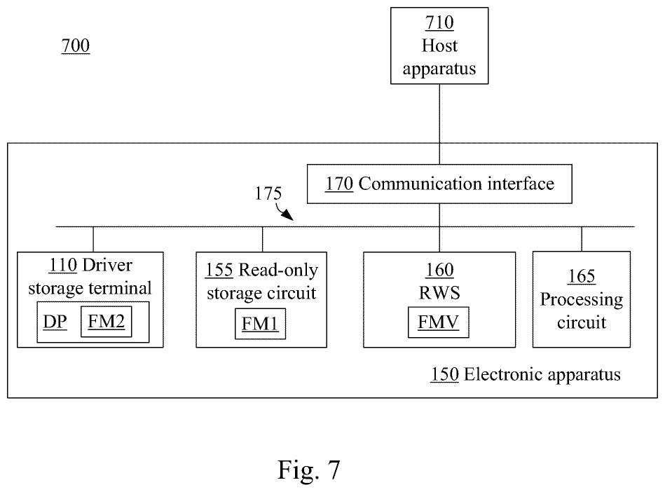

Reference is now made to FIG. 7. FIG. 7 illustrates a block diagram of an electronic system 700 according to another embodiment of the present invention.

Similar to FIG. 1, the electronic system 700 in FIG. 7 also includes the driver storage terminal 110 and the electronic apparatus 150. However, in the present embodiment, the driver storage terminal 110 is a flash memory further included by the electronic apparatus 150 and directly stores the driver DP. The driver storage terminal 110 may transmit the second version firmware FM2 in the driver DP directly through the internal bus 175 of the electronic apparatus 150 to the readable and writable storage circuit 160 of the electronic apparatus 150. The electronic apparatus 150 may accomplish the firmware forward and backward compatibility mechanism with the driver storage terminal 110 by using the method described above.

Based on such a configuration, the electronic apparatus 150 is still able to be electrically coupled with a host apparatus 710 and such a host apparatus 710 may include the components similar to the components included in the driver storage terminal 110 in FIG. 1. The driver storage terminal 110 may provide the driver DP to the host apparatus 700 through the path between the electronic apparatus 150 and the host apparatus 700 to drive the electronic apparatus 150.

As a result, the electronic apparatus of the present invention can be used in different types of electronic systems. It is appreciated that the electronic systems illustrated in FIG. 1 and FIG. 7 are merely an example. The present invention is not limited thereto.

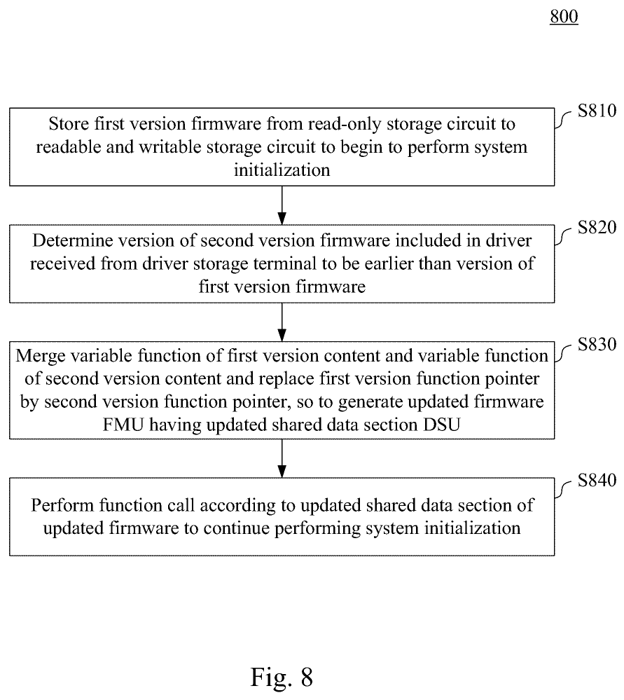

Reference is now made to FIG. 8. FIG. 8 illustrates a flow chart of an electronic apparatus initialization method 800 according to an embodiment of the present invention.

Besides the apparatus described above, the present invention further discloses the electronic apparatus initialization method 800 that can be used in such as, but not limited to the electronic apparatus 150 illustrated in FIG. 1. An embodiment of the electronic apparatus initialization method 800 is illustrated in FIG. 8 and includes the steps outlined below.

In step S810, the first version firmware FM1 is stored from the read-only storage circuit 155 to the readable and writable storage circuit 160 to begin to perform the system initialization.

In step S820, the version of the second version firmware FM2 included in the driver DP received from the driver storage terminal 110 is determined to be earlier than the version of the first version firmware FM1.

In step S830, the variable function of the first version content and the variable function of the second version content are merged and the first version function pointer is replaced by the second version function pointer, so to generate the updated firmware FMU having the updated shared data section DSU.

In step S840, function call is performed according to the updated shared data section DSU of the updated firmware FMU to continue performing the system initialization.

It is appreciated that the embodiments described above are merely an example. In other embodiments, it is appreciated that many modifications and changes may be made by those of ordinary skill in the art without departing, from the spirit of the invention. For example, the number of the variable functions, the non-variable functions and the third functions in the first version firmware and the second version firmware can be different depending on different requirements. Further, the first version firmware and the second version firmware may include other data or codes that the execution of the system initialization requires. The present invention is not limited to certain number of functions or certain configurations of the functions included in the first version firmware and the second version firmware.

In summary, the electronic system, the electronic apparatus and the initialization method thereof having firmware forward and backward compatibility mechanism load first version firmware in a read-only storage circuit to a readable and writable storage circuit and receive a second version firmware from a driver storage terminal to merge functions of the first version firmware and the second version firmware and replace the pointers of the functions in the first version firmware by the pointers of the corresponding functions in the second version firmware when the version of the functions in the first version firmware are different from the version of the corresponding functions in the second version firmware such that the electronic apparatus performs function call according to the updated pointers to perform system initialization. The compatibility of different firmware versions can be accomplished.

The aforementioned descriptions represent merely the preferred embodiments of the present disclosure, without any intention to limit the scope of the present disclosure thereto. Various equivalent changes, alterations, or modifications based on the claims of present disclosure are all consequently viewed as being embraced by the scope of the present disclosure.

What is claimed is:

1. An electronic apparatus having firmware forward and backward compatibility mechanism, comprising:
a read-only storage circuit configured to store first version firmware that comprises at least one variable function corresponding to a first version content and a first shared data section, and the first shared data section comprises a first version function pointer of the variable function;
a readable and writable storage circuit; and
a processing circuit configured to:
store the first version firmware from the read-only storage circuit to the readable and writable storage circuit to begin to perform a system initialization;
determine that a version of the second version firmware comprised in a driver received from a driver storage terminal is earlier than the version of the first version firmware, wherein the second version firmware comprises the variable function corresponding to a second version content and a second shared data section, and the second shared data section comprises a second version function pointer of the variable function, in which the second shared data section and the first shared data section have a same section structure;
merge the variable function of the first version content and the variable function of the second version content and replace the first version function pointer by the second version function pointer, so to generate updated firmware having an updated shared data section; and
perform function call according to the updated shared data section of the updated firmware to continue performing the system initialization.

2. The electronic apparatus of claim 1, wherein the first version firmware further comprises at least one non-variable function compatible in the second version firmware, the first shared data section comprises a non-variable function pointer of the non-variable function, and the second shared data section comprises an invalid pointer corresponding to the non-variable function; and
the processing circuit is further configured to keep the non-variable function pointer in the updated shared data section according to the invalid pointer to generate the updated firmware.

3. The electronic apparatus of claim 2, wherein the first version firmware comprises at least one third function not comprised by the second version firmware and comprises an additional shared data section that comprises a third function pointer of the third function; and
the processing circuit is further configured to merge the variable function of the first version content, the variable function of the second version content and the third function and keep the additional shared data section in the updated shared data section to generate the updated firmware.

4. The electronic apparatus of claim 1, wherein the section structure comprises an address allocation configuration and a section length.

5. The electronic apparatus of claim 1, wherein the driver comprises a plurality of firmware, and the processing circuit is further configured to:
perform a handshake process with the driver storage terminal such that the driver storage terminal retrieves one of the firmware that matches the electronic apparatus as the second version firmware; and
receive the second version firmware from the driver storage terminal.

6. The electronic apparatus of claim 1, wherein the first shared data section of the first version firmware further comprises a first global variable section, the second shared data section of the second version firmware further comprises a second global variable section, each of the first global variable section and the second global variable section comprises a shared data structure, and the first global variable section further selectively comprises a non-shared data structure disposed behind the shared data structure such that the updated firmware keeps the first global variable section.

7. The electronic apparatus of claim 6, wherein each of a plurality of global variables comprised by the first global variable section and the second global variable section has a variable attribute used to perform version identification.

8. The electronic apparatus of claim 1, wherein the driver storage terminal is a host apparatus independent from the electronic apparatus, is a master apparatus disposed in a system-on-a-chip together with the electronic apparatus or a flash memory further comprised by the electronic apparatus.

9. An electronic system, comprising:
a driver storage terminal; and
an electronic apparatus comprising:
a read-only storage circuit configured to store first version firmware that comprises at least one variable function corresponding to a first version content and a first shared data section, and the first shared data section comprises a first version function pointer of the variable function;
a readable and writable storage circuit; and
a processing circuit, configured to:
store the first version firmware from the read-only storage circuit to the readable and writable storage circuit to begin to perform a system initialization;
determine that a version of the second version firmware comprised in a driver received from the driver storage terminal is earlier than the version of the first version firmware, wherein the second version firmware comprises the variable function corresponding to a second version content and a second shared data section, and the second shared data section comprises a second version function pointer of the variable function, in which the second shared data section and the first shared data section have a same section structure;
merge the variable function of the first version content and the variable function of the second version content and replace the first version function pointer by the second version function pointer, so to generate updated firmware having an updated shared data section; and
perform function call according to the updated shared data section of the updated firmware to continue performing the system initialization.

10. The electronic system of claim 9, wherein the first version firmware further comprises at least one non-variable function compatible in the second version firmware, the first shared data section comprises a non-variable function pointer of the non-variable function, and the second shared data section comprises an invalid pointer corresponding to the non-variable function; and
the processing circuit is further configured to keep the non-variable function pointer in the updated shared data section according to the invalid pointer to generate the updated firmware.

11. The electronic system of claim 10, wherein the first version firmware comprises at least one third function not comprised by the second version firmware and comprises an additional shared data section that comprises a third function pointer of the third function; and
the processing circuit is further configured to merge the variable function of the first version content, the variable function of the second version content and the third function and keep the additional shared data section in the updated shared data section to generate the updated firmware.

12. The electronic system of claim 9, wherein the section structure comprises an address allocation configuration and a section length.

13. The electronic system of claim 9, wherein the driver comprises a plurality of firmware, and the processing circuit is further configured to:
perform a handshake process with the driver storage terminal such that the driver storage terminal retrieves one of the firmware that matches the electronic apparatus the most as the second version firmware; and
receive the second version firmware from the driver storage terminal.

14. The electronic system of claim 9, wherein the first shared data section of the first version firmware further comprises a first global variable section, the second shared data section of the second version firmware further comprises a second global variable section, each of the first global variable section and the second global variable section comprises a shared data structure, and the first global variable section further selectively comprises a non-shared data structure disposed behind the shared data structure such that the updated firmware keeps the first global variable section.

15. The electronic system of claim 14, wherein each of a plurality of global variables comprised by the first global variable section and the second global variable section has a variable attribute used to perform version identification.

16. The electronic system of claim 9, wherein the driver storage terminal is a host apparatus independent from the electronic apparatus, is a master apparatus disposed in a system-on-a-chip together with the electronic apparatus or a flash memory further comprised by the electronic apparatus.

17. An electronic apparatus initialization method used in an electronic apparatus, comprising:
storing first version firmware from a read-only storage circuit to a readable and writable storage circuit to begin to perform a system initialization, wherein the first version firmware comprises at least one variable function corresponding to a first version content and a first shared data section, and the first shared data section comprises a first version function pointer of the variable function;
determining that a version of a second version firmware comprised in a driver received from a driver storage terminal is earlier than the version of the first version firmware, wherein the second version firmware comprises the variable function corresponding to a second version content and a second shared data section, and the second shared data section comprises a second version function pointer of the variable function, in which the second shared data section and the first shared data section have a same section structure;
merging the variable function of the first version content and the variable function of the second version content and replacing the first version function pointer by the second version function pointer, so to generate updated firmware having an updated shared data section; and
performing function call according to the updated shared data section of the updated firmware to continue performing the system initialization.

18. The electronic apparatus initialization method of claim 17, wherein the first version firmware further comprises at least one non-variable function compatible in the second version firmware, the first shared data section comprises a non-variable function pointer of the non-variable function, and the second shared data section comprises an invalid pointer corresponding to the non-variable function, the electronic apparatus initialization method further comprising:
keeping the non-variable function pointer in the updated shared data section according to the invalid pointer to generate the updated firmware.

19. The electronic apparatus initialization method of claim 18, wherein the first version firmware comprises at least one third function not comprised by the second version firmware and comprises an additional shared data section that comprises a third function pointer of the third function, the electronic apparatus initialization method further comprising:
merging the variable function of the first version content, the variable function of the second version content and the third function and keeping the additional shared data section in the updated shared data section to generate the updated firmware.

20. The electronic apparatus initialization method of claim 17, wherein the driver comprises a plurality of firmware, the electronic apparatus initialization method further comprising:
performing a handshake process with the driver storage terminal such that the driver storage terminal retrieves one of the firmware that matches the electronic apparatus the most as the second version firmware; and
receiving the second version firmware from the driver storage terminal.
